(19) United States
(12) Patent Application Publication
(10) Pub. No.: US 2012/0048748 A1
(43) Pub. Date: Mar. 1, 2012

(54) Air Quality Analyzer

(76) Inventors: Charles E. Wickersham, JR., Columbus, OH (US); Gerhard Meyer, Worthington, OH (US)

(21) Appl. No.: 13/219,931

(22) Filed: Aug. 29, 2011

Related U.S. Application Data
(60) Provisional application No. 61/378,269, filed on Aug. 30, 2010.

(51) Int. Cl. G01N 27/26; B03C 3/16

(52) U.S. Cl. 205/789; 204/400; 204/412

(57) ABSTRACT

Air quality in a workplace can be monitored to ensure worker safety.

### CLAIM FOR PRIORITY

This application claims priority under 35 U.S.C. §119(e) to Provisional U.S. Patent Application Ser. No. 61/378,269, filed on Aug. 30, 2010, which is hereby incorporated by reference.

### TECHNICAL FIELD

The present invention relates to monitoring and analyzing air quality in a workplace.

### BACKGROUND

Determining particle concentrations within an air sample can be accomplished by drawing a known volume of air through a filter and capturing particles within the filter. After a suitable volume of air has been drawn through the filter, the filter can be analyzed using X-ray fluorescence (XRF) to determine the filter's contents. However, this type of analysis requires the filter to be transported to an XRF instrument where it often waits in a queue prior to analysis. As an alternative to XRF analysis, the filter can be rinsed to dislodge particles from the filter. During rinsing, the particles become suspended in a liquid, and the liquid can be analyzed for particle concentrations. Both of these filter-based methods are time consuming. In particular, filter-based methods may require several hours to draw a suitable volume of air through the filter, and the washing process may add several more hours to the process. Therefore, filter-based methods are not practical for rapidly analyzing air quality in a workplace.

### DESCRIPTION OF DRAWINGS

FIG. 1 is an example apparatus for analyzing air quality.

FIG. 2 is a plot showing potential versus time during an example oxidation step.

FIG. 3 is a plot showing potential versus time during an example oxidation step.

FIG. 4 is a plot showing potential versus time during an example oxidation step.

FIG. 5 is a method for analyzing a particle concentration in a sample.

FIG. 6 is a method for measuring the particle concentration in the method of FIG. 5.

### DETAILED DESCRIPTION

Manufacturing processes can introduce metal particles into a workplace environment. These metal particles do not biodegrade and can accumulate in the workplace over time. Since exposure to certain metals can produce undesirable effects in humans, it is desirable to monitor the concentration levels of metals within the workplace so that appropriate actions can be taken to ensure worker safety.

High technology electronics and other devices, such as solar panels or batteries, may contain heavy metals such as silver, arsenic, gold, barium, bismuth, cadmium, copper, gallium, germanium, mercury, indium, magnesium, nickel, lead, platinum, antimony, samarium, tin, tellurium, thallium, or zinc. During manufacturing, small concentrations of heavy metal particles may become airborne within a manufacturing location. It is desirable to measure and monitor concentrations of these metals within the manufacturing location for safety and environmental purposes. Unfortunately, current measurement devices are incapable of measuring extremely low concentrations of heavy metals within the workplace. Therefore, a portable apparatus has been developed that is capable of sampling air from the workplace environment and measuring concentrations of heavy metals within that sample.

In one aspect, a portable apparatus for analyzing air quality can include a trap configured to collect particles from an air sample in a liquid. The apparatus can include a measuring device including a measurement electrode configured to analyze the collected particles. The measuring device can include an auxiliary electrode, and a reference electrode. The measuring device can be configured to apply a stripping voltage to the electrodes. The measuring device can include a converter for converting the concentration of solid particles in the liquid to a concentration of solid particles in the air sample. The converter can include a computer connected to the trap and the measuring device.

The measuring device can be configured to measure concentrations of cadmium in the liquid ranging from about 100 ng/m3 to about 10,000 ng/m3. The measuring device can be configured to measure concentrations of tellurium in the liquid ranging from about 200 ng/m3 to about 10,000 ng/m3. The trap can draw in sample air at a rate of about 1 liter per minute to about 300 liters per minute. The trap can include an air intake system including an air passage having an inlet end and an outlet end, and an air pump configured to create an air stream through the air passage by drawing air into the air passage through the inlet end. The trap can include an ionization section located in the air intake system proximate the inlet end, wherein the ionization section is capable of ionizing particles in the air stream. The trap can include a collection electrode situated in the air intake system between the ionization section and the outlet end of the air intake system. The trap can include a reservoir containing a liquid, wherein the reservoir is hydraulically connected to the collection electrode.

The trap can include a liquid pump and a fluid flow path fluidly connecting the reservoir to an interior of the collection electrode. The trap can include a portable power source connected to the ionization section and the collection electrode to create an electrostatic field capable of ionizing particles in the air. Ionizable particles in the air stream can be electrostatically precipitated onto the collection electrode and collected in the liquid.

The trap can include an electrostatic precipitator. The trap can include a wet electrostatic precipitator. The apparatus can include a platform, wherein the trap and the measuring device are attached to a top surface of the platform. The apparatus can include a nitrogen gas generator connected to the measuring device. Alternately, the apparatus can use compressed gas from a cylinder attached to the apparatus. The apparatus can include a power supply connected to the precipitator and the measuring device. The apparatus can include three or more wheels attached to a bottom surface of the platform.

In another aspect, a method for analyzing air quality can include trapping a plurality of solid particles present in an air sample in a liquid, measuring the particle concentration of solid particles in the liquid, and calculating a concentration of solid particles in the air sample based on the concentration of solid particles in the liquid.

The method can include drawing a volume of air into the trap before trapping the plurality of solid particles present in the air sample. The method can include ionizing the volume of air within the trap to ionize the solid particles. The method can include energizing a collection electrode to attract the ionized solid particles. Depositing the plurality of solid particles in a liquid can include pumping a volume of liquid over the collection electrode to capture the ionized particles.

Measuring the particle concentration of the solid particles in the liquid can include electrochemically measuring the particle concentration of the solid particles in the liquid. For example, electrochemically measuring the particle concentration of the solid particles in the liquid can include using stripping voltammetry. Measuring a particle concentration within the liquid using stripping voltammetry can include energizing a working electrode (which can be a measurement electrode) to attract particles to the working electrode, oxidizing particles adjacent to the working electrode, and measuring a current signal resulting from oxidizing the particles. Measuring a particle concentration within the liquid using stripping voltammetry can include converting the current signal to a particle concentration. The plurality of solid particles can include cadmium. The plurality of solid particles can include tellurium.

The method may further include automatically transferring the liquid from a trapping device to a measuring device before measuring the particle concentration. The liquid may be automatically transferred by pumping the liquid from the trapping device to the measuring device, and pumping can be controlled by a computer.

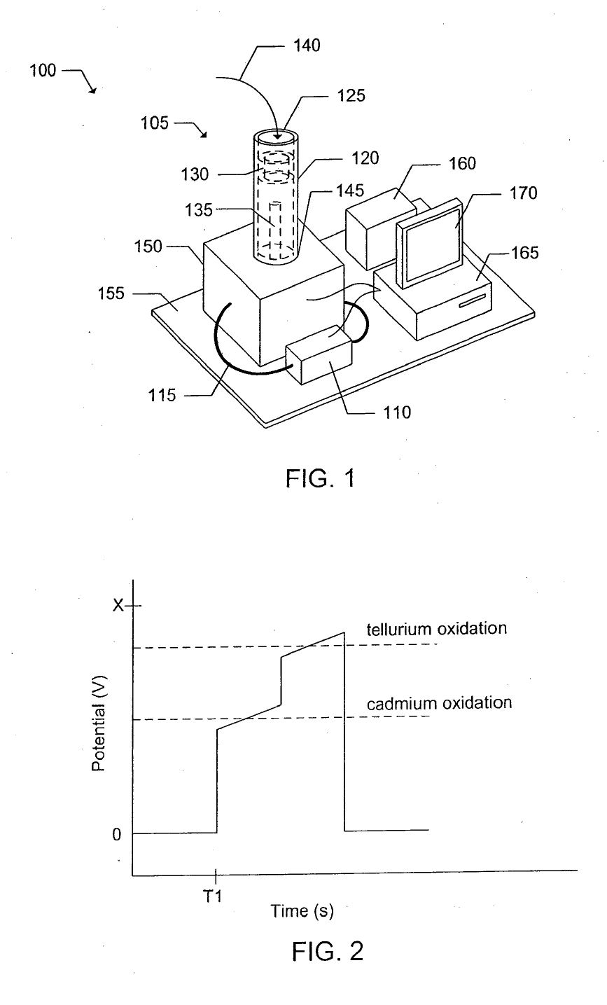

As shown by way of example in FIG. 1, the apparatus 100 may include a trap 105 and a measuring device 110. The trap 105 may be a portable air sampling system. For example, the trap may include any suitable air sampling device. Trap 105 can include an electrostatic precipitator, such as a wet electrostatic precipitator. One example of a wet electrostatic precipitator suitable for use in trap 105 is the Air to Liquid Particle extraction System (ALPXS) available from Meinhard Glass Products in Golden, Colo. Technology in Meinhard's ALPXS was developed by Westinghouse Savannah River Co. LLC and is the subject of U.S. patent application Ser. No. 10/287,409, filed on Nov. 4, 2002, which is incorporated by reference in its entirety.

Trap 105 may use any suitable solid-particle trapping technology to trap solid particles in samples of the air, such as air in a factory environment. Trap 105 can trap any suitable solid particle. Trap 105 can trap any suitable solid material particle, including mineral particles, metal particles, polymeric particles, and/or plastic particles, and/or any other suitable solid material particle that can be present in the air. Trap 105 can trap conductive, semiconductive, and/or insulative solid particles. Trap 105 can collect, for example, cadmium and/or tellurium particles.

Trap 105 can include a wet electrostatic precipitator configured to operate on the principle of wet electrostatic precipitation to collect and concentrate airborne metals into a liquid sample that can be analyzed. Where trap 105 uses electrostatic precipitation, trap 105 may function by drawing in sample air at a rate up to about 300 liters per minute, charging the sample air at 7,000-8,000 volts to ionize particles within the sample, and collecting the ionized particles in a liquid volume of about 20-30 mL.

The trap can draw in sample air at a rate of about 1 liter per minute to about 300 liters per minute. Preferably, the trap may draw in sample air at a rate of about 200 liters per minute to about 300 liters per minute. Where lower flow rates are desired, the air intake rate can be reduced to a level between about 1 liter per minute and about 200 liters per minute by including an air passage restriction, such as a throttle or other suitable flow restricting device, proximate to the inlet. The sampling time may last about 30 minutes. However, longer or shorter sampling times may be used.

When operating at high flow rates, the precipitator may produce concentration factors approaching 100,000 within minutes of sampling, and the collection efficiency can be greater than 90 percent for particles less than 0.3 micrometers in diameter. The precipitator's collection efficiency for small particle sizes represents a substantial improvement over filter-based methods which are limited by filter pore size.

Trap 105 may include an air intake system including an air pump and an air passage 120, where the air passage 120 may have an inlet end 125 and an outlet end 145. The air pump may produce an air stream through the air passage 120 by drawing air into the air passage through the inlet end 125 of the passage 120. The direction of the flow stream is shown with an arrow 140. Trap 105 may include an ionization section 130 located in the air intake system proximate to the inlet end 125 of the air passage 120. The ionization section 130 may ionize particles in the air stream by charging the air stream at about 7,000-8,000 volts. The ionized particles may collect adjacent to a collection electrode 135 situated in the air intake system between the ionization section 130 and the outlet end 145 of the air intake system. Trap 105 may include a reservoir 150 containing a liquid. A liquid pump may circulate the liquid from the reservoir 150 to the collection electrode 135 through hydraulic connections. The liquid may flow upwardly through an interior cavity in the collection electrode 135, flow over a top end of the collection electrode, and cascade down over an outer surface of the collection electrode. While cascading over the outer surface of the collection electrode 135, the liquid may capture and carry away the ionized particles. The liquid containing the ionized particles may then be recirculated to the reservoir 150.

Once the metal particles are captured within the liquid, the liquid from the reservoir 150 can be pumped via hydraulic connections 115 to a measuring device 110 where the liquid can be analyzed for various metal concentrations. The measuring device 110 may use any suitable measurement technique such as, for example, atomic optical emission, absorption spectrometry, mass spectrometry, nuclear activation, x-ray energy, wavelength dispersive techniques, inductively coupled plasma optical emission spectrometry (ICP/OES), or anodic stripping voltammetry (ASV). A device employing ASV is commercially available from Metrohm Schweiz A G.

ASV is a sensitive and precise technique for detecting trace concentrations of metals in liquid samples. ASV may be applied to samples collected from workplace environments to determine various metal concentrations. For example, ASV can be used to measure ions of the following metals: silver (Ag), arsenic (As), gold (Au), barium (Ba), bismuth (Bi), cadmium (Cd), copper (Cu), gallium (Ga), germanium (Ge), mercury (Hg), indium (In), magnesium (Mg), nickel (Ni), lead (Pb), platinum (Pt), antimony (Sb), samarium (Sm), tin (Sn), tellurium (Te), thallium (Tl), and zinc (Zn).

The measuring device 110 may be an electrochemical device including an electrode system and a glass container or cell configured to hold a sample solution containing particles. The electrode system includes a working electrode, a reference electrode, and an auxiliary electrode. The working electrode may be a mercury drop electrode or a thin film mercury electrode. The auxiliary electrode may include platinum foil. The device may also include a glass tube containing a frit for bubbling pure nitrogen through the sample solution to remove dissolved oxygen. The apparatus may include a nitrogen gas source to supply nitrogen to the measuring device.

The measuring device 110 may use voltammetric technique to extract metal particles from a solution by electroplating the particles onto a working electrode. This effectiveness of this step may be enhanced by stirring the solution or moving the working electrode within the solution. The duration of the electroplating step is dependent upon the concentration of the metal ions in the solution and may vary from less than 1 min at a level of 0.1 mg/L (0.1 ppm) to about 10 min at a level of 1.0 micro-gram/L (1 ppb). The metals are then oxidized from the working electrode during a stripping step. Cadmium stripping occurs at about −0.56 volts, and tellurium stripping occurs at about −1.01 volts. The current is measured during the stripping step, and a peak in the current signal is observed at the potential where the species begin to oxidize. A sensitivity of 0.1 ng may be achieved at +/−10% relative standard deviation.

The apparatus 100 may include a platform 155 or cart upon which trap 105 and the measuring device 110 are mounted. The platform 155 may any suitable material capable of supporting the trap and measuring device and capable of receiving fasteners for mounting. For example, the platform 155 may be a sheet of steel, aluminum, polycarbonate, plastic, fiberglass, or carbon fiber.

The apparatus 100 may be portable. Portability may be achieved by maintaining a small size or by incorporating wheels to improve mobility. For example, the apparatus may include three or more wheels to provide stability and mobility. The wheels may be mounted to a bottom surface of the platform, to a plurality of legs extending from the platform, or to any other suitable surface of the apparatus.

The apparatus 100 may include an electronics module which allows it to receive electrical power from a standard wall outlet and convert and transfer that power to the precipitator and the measurement device. In particular, the electronics module may be capable of receiving electrical power at about 110 volts and converting that electrical power to about 7,000-8,000 volts for the ionizing process within the precipitator. To improve portability, the apparatus may include an on-board power source 160 mounted to the platform 155. The power source 160 may include any suitable source of electrical power, including an electrical storage device such as battery or a capacitor. Power source 160 can include an inverter to convert direct current from a batter to alternating current. Power source 160 can include any other suitable source of electrical power, including any suitable electrical generator.

The apparatus 100 may include a converter configured to convert the concentration of solid particles in the liquid to a concentration of solid particles in the air sample. The converter can perform this conversion by keeping track of the volume of air sample that resulted in the calculated solid particle concentration in the liquid and corresponding the concentration of the solid particles in the liquid to a concentration in the volume of air sample. The apparatus can include computer 165, which can include the converter, and the apparatus may be computer-controlled. For example, trap 105, electronics module, and measuring device 110 may be connected to the computer 165. The computer 165 may be connected to the apparatus through a wireless or wired connection. The computer 165 may include a software application which provides a graphical user interface (GUI) displayable on a screen 170. The GUI may allow a user to interact with the apparatus. The user may, for example, set up and initiate new air quality tests, monitor ongoing tests, and recall results from previously executed tests. When setting up a new test within the GUI, the user may establish sampling durations, species of interest, and output desired.

During a standard air quality test, the measurement device 110 may scan a wide range of electrical potentials to identify all species present in the liquid. However, to reduce testing time, the user may indicate that only one species is of interest. For example, the user may indicate that cadmium is the only species of interest. Then, upon drawing a suitable volume of air through the precipitator, the measurement device can target cadmium. In particular, the stripping step can commence by providing an electrical potential slightly lower than the potential needed to oxidize cadmium. The electrical potential can then be ramped slowly to oxidize any cadmium that may be affixed to the working electrode. A similar process may be used to determine tellurium concentration within the liquid.

The apparatus 100 may be programmed to test air quality continuously or at intervals. For example, the apparatus may be placed near a solar panel manufacturing line and may test air quality at about 30 minute intervals. The apparatus 100 may be programmed to test air quality throughout the day or only during specific times. For example, the apparatus 100 may test air quality during a specific manufacturing process. As a result of its portability, the apparatus can be easily relocated within a manufacturing facility to allow air quality proximate to specific manufacturing processes to be tested. For instance, air quality near a first assembly line may be tested in the morning, and air quality near a second assembly line may be tested in the afternoon. As a result of its portability, a single apparatus may satisfy the testing needs of a large manufacturing facility, thereby providing a cost-effective solution for air quality monitoring.

Tests that determine individual species may be combined to provide a single test that determines concentrations of two or more species. For example, a test may combine a test for tellurium and a test for cadmium as shown in FIG. 2. In particular, a first energizing event may provide a first electrical potential to the working electrode for a duration suitable to promote cadmium oxidation. Since cadmium stripping occurs at about −0.56 volts, the first energizing event may include any suitable voltage waveform sufficient to oxidize. cadmium. For example, the first energizing event may include a square wave having a voltage equal to or greater than −0.56 volts. Alternately, the first energizing event may include ramping the voltage across −0.56 volts to promote cadmium oxidation. In particular, the first energizing event may include ramping a voltage from a voltage less than −0.56 volts to a voltage greater than −0.56 volts, and the voltage may be ramped linearly or nonlinearly.

As shown in FIG. 2, the first energizing event may be followed by a second energizing event in which a second electrical potential is provided to the working electrode for a duration suitable to promote tellurium oxidation. Since tellurium oxidation occurs at about −1.01 volts, the second energizing event may include any suitable voltage waveform sufficient to oxidize tellurium. For example, the second energizing event may include a square wave having a voltage equal to or greater than −1.01 volts. Alternately, the second energizing event may include ramping the voltage across −1.01 volts to promote tellurium oxidation. In particular, the second energizing event may include ramping a voltage from a voltage less than −1.01 volts to a voltage greater than −1.01 volts, and the voltage may be ramped linearly or nonlinearly.

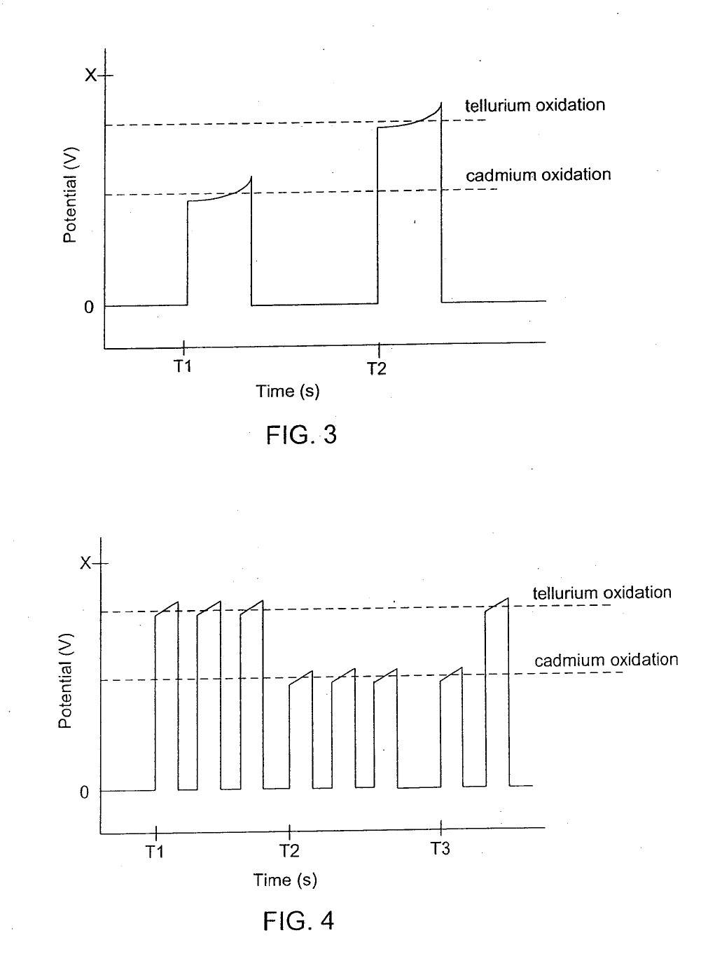

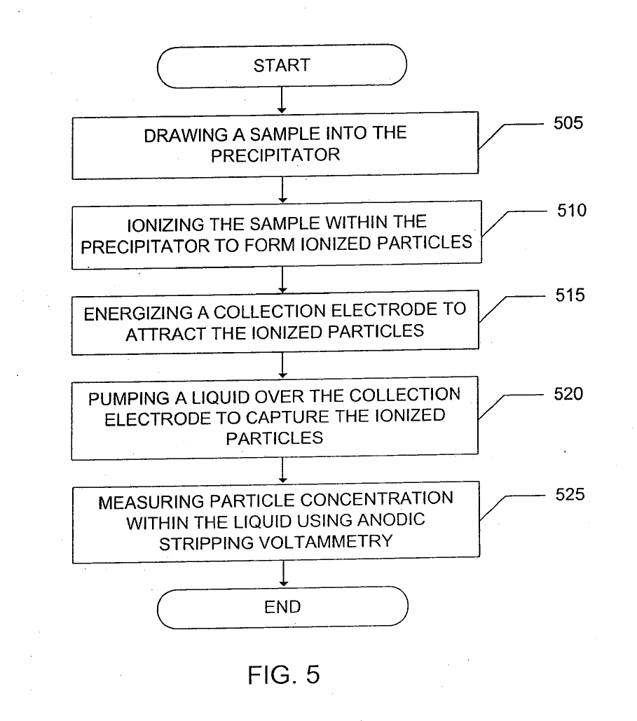

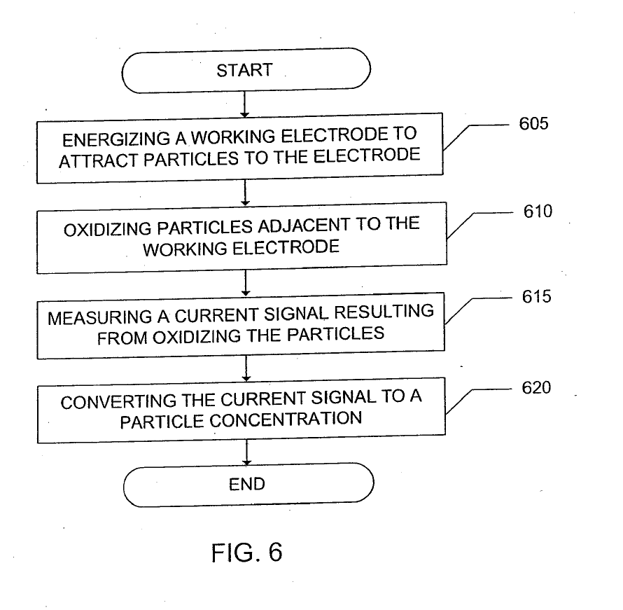

The second energizing event may occur immediately after the first energizing event as shown in FIG. 2. Alternately, a time gap may exist between the first and second energizing events as shown in FIG. 3. In addition, the energizing events may correspond with manufacturing processes occurring proximate to the apparatus 100, as shown in FIG. 4. For example, if a layer containing tellurium is applied to a solar panel starting at T1, the apparatus may be programmed to test for tellurium during that process. If a second manufacturing process commences at T2 in which a layer containing cadmium is applied to the solar panel, the apparatus may be programmed to test for cadmium during that process. Similarly, if a third manufacturing process commences at T3 in which a layer containing cadmium and tellurium is applied to the solar panel, the apparatus may be programmed to test for both metals.

The computer 165 may receive data from the apparatus 100. For example, the computer may receive data including a concentration of cadmium in the liquid, the volume of liquid in the reservoir, and the volume of air which was sampled by trap 105. From this data, the computer can calculate the concentration of cadmium within the workplace environment. This information can be reported on a weight or mass basis per cubic meter of air and may be displayed on the screen 170.

Although an electrostatic method is described for collecting particles from an air sample, this is not limiting. For instance, particles may be collected using any suitable method such as, for example, by bubbling factory air through an acidic water bath and capturing particles from the air within the acidic water bath. The particles in the acidic water bath can then be analyzed using ASV or any other suitable method.

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. Also, it should also be understood that the appended drawings are not necessarily to scale, presenting a somewhat simplified representation of various features and basic principles of the invention.

What is claimed is:

1. A portable apparatus for analyzing air quality comprising:
a trap configured to collect particles from an air sample in a liquid; and
a measuring device including a measurement electrode configured to analyze the collected particles.

2. The apparatus of claim 1, wherein the measuring device further includes an auxiliary electrode, and a reference electrode.

3. The apparatus of claim 2, wherein the measuring device is configured to apply a stripping voltage to the electrodes.

4. The apparatus of claim 1, wherein the measuring device is configured to measure concentrations of cadmium in the liquid ranging from about 100 ng/m3 to about 10,000 ng/m3.

5. The apparatus of claim 1, wherein the measuring device is configured to measure concentrations of tellurium in the liquid ranging from about 200 ng/m3 to about 10,000 ng/m3.

6. The apparatus of claim 1, wherein the trap draws in sample air at a rate of about 1 liters per minute to about 300 liters per minute.

7. The apparatus of claim 1, wherein the trap comprises an air intake system comprising an air passage having an inlet end and an outlet end, and an air pump configured to create an air stream through the air passage by drawing air into the air passage through the inlet end.

8. The apparatus of claim 7, wherein the trap comprises an ionization section located in the air intake system proximate the inlet end, wherein the ionization section is capable of ionizing particles in the air stream.

9. The apparatus of claim 8, wherein the trap comprises a collection electrode situated in the air intake system between the ionization section and the outlet end of the air intake system.

10. The apparatus of claim 9, wherein the trap comprises a reservoir containing a liquid, wherein the reservoir is hydraulically connected to the collection electrode.

11. The apparatus of claim 10, wherein the trap comprises a liquid pump and a fluid flow path fluidly connecting the reservoir to an interior of the collection electrode.

12. The apparatus of claim 11, wherein the trap comprises a portable power source connected to the ionization section and the collection electrode to create an electrostatic field capable of ionizing particles in the air.

13. The apparatus of claim 12, wherein ionizable particles in the air stream are electrostatically precipitated onto the collection electrode and collected in the liquid.

14. The apparatus claim 1, wherein the trap comprises an electrostatic precipitator.

15. The apparatus of claim 1, further comprising a platform, wherein the trap and the measuring device are attached to a top surface of the platform.

16. The apparatus of claim 1, further comprising a nitrogen gas source connected to the measuring device.

17. The apparatus of claim 1, further comprising a power supply connected to the precipitator and the measuring device.

18. A method for analyzing air quality, the method comprising:
trapping a plurality of solid particles present in an air sample in a liquid;
measuring the particle concentration of solid particles in the liquid; and
calculating a concentration of solid particles in the air sample based on the concentration of solid particles in the liquid.

19. The method of claim 18, further comprising drawing a volume of air into a trap before trapping the plurality of solid particles present in the air sample.

20. The method of claim 19, further comprising ionizing the volume of air within the trap to ionize the solid particles.

21. The method of claim 20, further comprising energizing a collection electrode to attract the ionized solid particles.

22. The method of claim 18, wherein depositing the plurality of solid particles in a liquid comprises pumping a volume of liquid over the collection electrode to capture the ionized particles.

23. The method of claim 18, wherein measuring the particle concentration of the solid particles in the liquid comprises electrochemically measuring the particle concentration of the solid particles in the liquid.

24. The method of claim 23, wherein electrochemically measuring the particle concentration of the solid particles in the liquid comprises using anodic stripping voltammetry.

25. The method of claim 24, wherein measuring a particle concentration within the liquid using anodic stripping voltammetry comprises:
energizing a measurement electrode to attract particles to the measurement electrode;
oxidizing particles adjacent to the measurement electrode; and
measuring a current signal resulting from oxidizing the particles.

26. The method of claim 25, wherein measuring a particle concentration within the liquid using anodic stripping voltammetry further comprises converting the current signal to a particle concentration.

27. The method of claim 18, wherein the plurality of solid particles comprises cadmium.

28. The method of claim 18, wherein the plurality of solid particles comprises tellurium.

29. The method of claim 18, further comprising automatically transferring the liquid from a trapping device to a measuring device before measuring the particle concentration.

30. The method of claim 29, wherein the liquid is automatically transferred by pumping the liquid from the trapping device to the measuring device, wherein pumping is controlled by a computer.
